(19) United States
(12) Patent Application Publication
(10) Pub. No.: US 2012/0115113 A1
(43) Pub. Date: May 10, 2012

(54) METHOD FOR PLAYING DYNAMIC ENGLISH GRAPHICS OPTIMIZED TO VISUAL PROCESSING PATTERNS OF BRAIN

(76) Inventor: Hyo Sang Shin, Seoul (KR)

(21) Appl. No.: 13/375,258

(22) PCT Filed: Dec. 6, 2010
(86) PCT No.: PCT/KR10/08681

§ 371 Date: Nov. 30, 2011

(30) Foreign Application Priority Data
Jan. 27, 2010 (KR) 10-2010-0007200

(51) Int. Cl. G09B 19/06

(52) U.S. Cl. 434/157

(57) ABSTRACT

Disclosed is a substantial playing method of merging actions or piping actions or moving actions in accordance with Universal Grammar, wherein the brain is stimulated through vision, and particularly, the deficient English-understanding mechanism parts of each user are stimulated more. In the early stages, the present invention stimulates the left-brain side which is in charge of quickly understanding sequential and consecutive English sentences more, and in the later stages, the invention stimulates both eyes and both brains together like a person who uses English as a native language more, thereby ultimately lowering the operating load per unit time in each side of the brain and increasing an English reading processing capacity per unit time and reading speed. The invention includes: a step D for deriving early visual processing pattern values; a step E for setting dynamic change directions of individual language elements that induce merging actions or piping actions or moving actions according to the early visual processing pattern values; a step F for deriving latter visual processing pattern values; and a step G for changing a dynamic change speed or the dynamic change directions of the individual language elements from the latter visual processing pattern values. If the steps are efficiently played, in the brain visual processing patterns of the user, the ability to quickly and consecutively interpret the medium and short sentences and the ability to comprehensively interpret the entire long sentences at a glance are uniformly developed.

### BACKGROUND OF THE INVENTION

The present invention disclosed herein relates a scientific English teaching method, and more particularly, to a playing technology for intentionally stimulating the brain structure including the optical nerves, through changing English graphic patterns.

(Background 1.) The present invention is an invention provided by developing Korean Patent application No. 10-2009-0211688 (hereinafter, referred to as a prior application), entitled “Dynamic graphic playing of English sentence for speed reading,” filed on Dec. 9, 2009, by the inventor of the present application.

The basic method and principle for playing dynamic English graphics according to the present invention are disclosed in the earlier application, and detailed descriptions thereof will now be repeated so as to clearly describe the characteristic features of the present invention. However, all the technical meanings of the present invention and the scope of right of the present invention should be interpreted as including the contents of the earlier application filed by the present inventor.

(Background 2.) According to studies conducted so far, brains of living organisms including the brains of humans are considered that they basically store and process data based on materials. In other words, brains of humans receive, process, and output data through storing, processing, and calling processes using material and real structures such as sensory cells such as retinas, cortices, and various nervous systems and neurotransmitters.

With the development of research on brains, various exact methods have been proposed to find out differences among thinking patterns (information processing trends) of persons according to the development levels of the their left and right brains. In most brain structure determining methods (left-right brain type determination methods), the thinking region of a left brain and the thinking region of a right brain can be distinguished very accurately, and detailed and various test methods are used according to the genders, ages, intellectual levels of subjects.

(Background 3.) Visual organs play a major role when a brain processes information, and optical nerves of a human that connect left and right eyes and left and right brains are not completely combined or separated but are cross-linked in a unique X-type format so that information processing in a brain of each person is carried out in certain trends or inherent patterns.

For example, when a native English speaker reads, writes, and talks in English, a particular region of the brain of the native English speaker is activated, and the particular region is different from a particular region of the brain of a non-native English speaker that is activated when the non-native English speaker reads, writes, and talks in English.

However, if the movement of the eyeballs of a native-like English speaker and scan images of the brain of the native-like English speaker are observed, the eyeball movement and brain activation patterns of the native-like English speaker are similar to those of a native English speaker. Therefore, according to the above-mentioned studies, when the brain of a person processes visual information during a certain task (for example, during information processing for a non-native language), a region of the brain that is unnecessarily activated or is required to be further activated may be accurately observed and determined. Such observation and determination may be more accurate and diverse with the advance of brain scanning technology and brain structure research.

### SUMMARY OF THE INVENTION

When reading text in a certain language, the brain mechanism for reading and interpreting the text of a person whose native language is that of the text, is different from the brain mechanism for reading and interpreting the text of a person to whom the text language is a foreign language and who must read the text while translating it into his/her native language.

Also, amongst those with the same native language, there are differences from person to person in the ability to read and interpret text in their native language at a fast pace. Even when taking into account differences between individuals, the difference in reading speed can be accredited to different brain mechanisms at work for reading and interpreting language expressed in sentences.

For a long time, many people from many different countries who were learning English as a second language have striven to acquire the skill of reading and interpreting English at equal or better levels of speed and accuracy than those who were born in English speaking countries and who used English as their native language. However, while those for whom English is a native language are able to amply perceive the structure of English sentences in three dimensions to understand the sentences, a person who has learned English as a second language is confined to a two-dimensional grammatical structural framework and is thus unable to escape from the constraints of having to disassemble an English sentence with the eyes and then reassemble the segments within the brain. It has therefore been difficult to achieve the same reading speed as a native language user, and even with a person that is able to read at a certain pace, after having read a long sentence, the person's memory is short-lived, resulting in an overall drop in comprehension.

Therefore, according to the prior application (KR 10-2009-0121688), a computer recognizes inputted English sentences, divides the inputted English sentences into individual meaningful language elements and meaningful spaces surrounding the individual meaningful language elements, overlaps additional static graphics expressed as proper geometrical symbols suitable for the principles of merging, piping, and moving on original static data located in each region of the elements and the spaces, and outputs the overlapped graphic data or outputs new dynamic graphics including distinctive motion information which are designed to involve the principles of merging, piping, and moving by deforming the original static graphic data in the regions. Thus, the language interpretation mechanism of the brain of a user directly connected to optical nerves can be developed and optimized like the language interpretation mechanism of brains of native speakers through repeated practice using the invention of the prior application.

Regardless of the brain characteristics of a user, the reading speed of the user may be increased by 300% on average and the comprehension ability of the user may be increased by 30% or more if dynamic English graphics corresponding to 2000 pages of reading material are played for the user for 10 weeks according to the invention of the prior application. This is an improvement of 3 times or more over traditional book-based speed reading training methods that employ direct reading and direct comprehension/sequential translation. However, it may take much time for some users to reach the above-mentioned level, or the reading speeds of they may not improve over the above-mentioned level.

It is considered that such leaning ability limitation is caused by information processing characteristics of brains of learners.

According to results of studies, if the left brain good at arithmetic operations is the dominant hemisphere of a person and the right eye connected to the left brain is the dominant eye of the person (the nervous systems connecting the brain and the other part of the body are crossed), the person generally has a good linguistic ability. If the right brain good at overall, sensuous, and abstract processing is the dominant hemisphere of a person and the left eye connected to the right brain is the dominant eye of the person, the person generally has a relatively low linguistic ability. However, this is not always right. For example, it is difficult to say that the left-brained linguistic ability of rapidly interpreting new sentences and rapidly reading conversation, middle-length, and short sentences is superior to the right-brained linguistic ability of generally reading a large amount of text and comprehensively catching new meaning of the text.

Therefore, it may need to consider the important aspect of the linguistic ability.

Primary limitation in learning English is lack of left-brained thinking for persons learning English as a second language and wanting to have at least the same reading ability as native speakers, particularly, middle educated native speakers. In addition, some of left-brained persons do not improve above the aforementioned limitation, which is due to lack of right-brained linguistic ability of overall and comprehensive reading.

Therefore, it is necessary to analyze various aspect of linguistic ability and systematically develop the linguistic ability for developing English speed reading ability.

According to the present invention, after users reach a certain learning level, the users can link their left and right brains without being limited by inherent brain characteristics so as to rapidly read text. Therefore, the present invention may useful for those who wish to improve their English speed reading ability using dynamic English graphics, particularly, those who wish to reach a high learning level for reading text three dimensionally at a high speed with high comprehension.

According to the present invention, in order to actualize a sentence graphic model having a dynamic image by means of a computer-based display device for an operating structure for merging, piping, and moving of a certain sentence on a computer screen, and a method for actually driving the dynamic image, a sentence recognition program and a character animating tool disclosed in the prior application is used for converting and storing characters captured in a predetermined sentence special region input in a computer as a separate language element capable of moving, and converting movement of the separate language element according to the merging, piping, moving principles into dynamic sentence data using geometric flat symbols or physical 3D information.

The dynamic sentence data are output on a screen in the form of shapes and movements of each separate language element based on meaningful language elements in the predetermined sentence determined by a sentence perception unit, in other words, based on the sentence back bone determining the overall meaning of the sentence.

Here, the determining of merging, piping, and moving the remaining linguistic elements including the meaningful linguistic element or sentence back bone is basically left to the currently widely known automated translation system's sentence recognition ability.

For example, in the future, according to the advance of (automated translation) artificial intelligence, it may be determined to unfold a sentence through merging & piping or to unfold the sentence through merging & moving, etc. However, in any case, these are intrinsically preliminary steps for the technical idea of the present invention.

That is, the present invention is an invention pertaining to technology that contributes in reality to graphic effects on sentences recognized through the ability of artificial intelligence of the currently known computer, and the accuracy of its determining (actually, this point is debated amongst linguistic scholars) does not by itself infringe or take away from the dynamic graphic conversion concept of the present invention.

Next, according to the present invention, the brain and vision characteristics of users are classified into about two (left brain, right brain) or four (left brain—right eye, left brain—left eye, right brain—left eye, and right brain—right eye) by using a left-right brain type determination method introduced in background 2 and a left-right dominant eye determination method, so as to display the dynamic sentence data on a computer screen using a pattern optimized to the visual processing habit of user's brain or a pattern for compensating for demerits of the visual processing habit of user's brain.

Thereafter, while the dynamic sentence data is played according to a certain optimized pattern, responses of user's brain and eyes are inspected by using the brain scanning method and eyeball tracking method introduced in background 3, and the inspect result is compared with a reference academic achievement to select and play better dynamic sentence data.

In embodiments of the present invention, determination of the dominant hemisphere and the dominant eye are performed according to current brain research technology, and brain scanning and eyeball tracking are performed according to current research technology. In addition, current research technology is used to measure how much user catches dynamic sentence data optimized to a specific pattern, and thus the reliability of the measurement is determined by the current research technology. In other words, accuracies in measuring the brain structure of a subject, the potential of a specific region of the visual system, and activation of the specific region are only background for realizing the technology idea of the present invention.

According to the playing method of the present invention, the brain is stimulated to make up for the English comprehension mechanism of each user. In an initial step, the left brain used to rapidly understand sequential and continuous English sentences is stimulated more than the right brain, and in a later step, both left and right eyes and brains are stimulated so that both eyes and brains can be used to rapidly read English sentences. Eventually, the average process load of each region of the brain can be reduced but the English reading speed can be increased.

In addition, according to the present invention, the ability of rapidly and continuously reading a middle-length sentence, and the ability of comprehensively catching the overall context of a long sentence can be evenly developed. Therefore, the overall English comprehension ability of a user can be wholly increased as compared with the case of simply training English grammar.

According to the present invention, even an ordinary non-native user not having an excellent potential can have a high-speed English reading ability in the range from 400 words/min to 1000 words/min. That is, the academic achievement can be improved to a high level that is difficult to reach in the prior application according to the brain characteristics and visual processing pattern of each user.

### BRIEF DESCRIPTION OF THE DRAWINGS

(Note) Color dynamic graphics may not be exactly present in the accompanying drawings submitted in standard drawing format (compressed monochrome TIFF format). Thus, refer to the drawings of Korean Patent No. 10-0968364 (Application No. KR-2009-0121688) to which the present application claims priority.

FIG. 1 is a view illustrating processed 3D magnetic resonance images for explaining shapes and names of regions of a brain, and thickness variations of the cortex of the brain and activation levels of the brain during a brain activity.

FIG. 2 is a view illustrating levels of measurement variables of brain visual processing patterns used for a playing method of the present invention.

FIG. 3 is a flowchart for explaining a basic method of playing dynamic English graphics for implementing the present invention.

FIG. 4 is a flowchart for explaining steps of a method for playing optimal dynamic English graphics according to the present invention.

FIG. 5 is a detailed flowchart for explaining Step D.

FIG. 6 is a detailed flowchart for explaining Step E.

FIG. 7 illustrates an example of a playing pattern of dynamic English graphics (merging and piping).

FIG. 8 illustrates an example of a playing pattern of dynamic English graphics (moving).

*Explanation of reference numerals of main elements of the drawings

1; meaningful separate language elements

d1 (L, R, A); dominant eye test result values

d2(L, R, A); dominant brain test result values

1^{st} jump area;

2^{nd} jump area;

### DETAILED DESCRIPTION OF PREFERRED EMBODIMENTS

Scientists have used 3D magnetic resonance imaging technology and two other methods to measure differences of brain structures. In one of the two methods, brains are divided into several regions, and sizes of particular regions are compared. In the other method, brains are divided according to tissue, and the amounts of gray matters of particular regions of the brains are compared.

Gray matter is a region of the central nervous system (brain and spinal cord) of a vertebrate where nerve cells are concentrated. When central nerves are observed with naked eyes, the gray matter looks gray. The gray matter is constituted by nerve cells, neurodendrites, unmyelinated nerves, etc.

The gray matter is located in the center region of the spinal cord and has an H-shape in a cross section of the spinal cord. The gray matter is located on the outer surfaces of the cerebellum and cerebral hemisphere and called cerebellar cortex and cerebral cortex, respectively. The brain has a plurality of gray lumps in the white matters, and the gray lumps are called nerve nuclei. Many nerve nuclei exist from the medulla oblongata to the diencephalon.

The structures of the spinal cord and the brain are different largely in the arrangement of gray matter and white matter. In the brain protected by the cranium, the white matter is located in center regions and the gray matter is outer regions for facilitating multiple access. In the conical cord partially protected by a plurality of vertebrae and joints, the white matter is located outside the gray matter to protect the gray matter. From this, it can be estimated that the gray matter is more difficult to regenerate and information is processed in the gray matter.

The present invention will now be described in detail based on the above-described characteristics of the brain and the (cross) optical nervous system connected to the brain. However, the scope and spirit of the present invention are not limited by elements indicated by specific terms and combined structures of the elements that are explained in the following description.

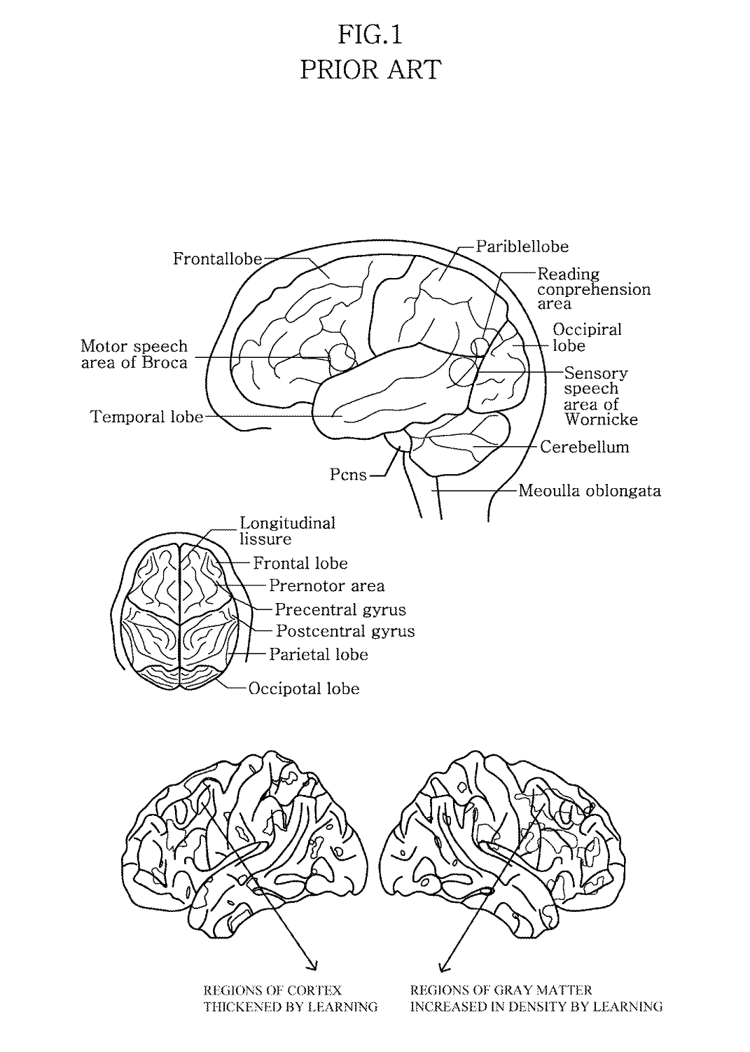

In the upper portion of FIG. 1, shapes and names of a brain are illustrated (refer to the drawings of the prior application to which the present application claims priority for other parts not shown in FIG. 1). According to research by scientists, it is known that optical nerves are crossed in X-shape in the brain to transmit an image formed on the retina to the opposite occipital lobe as if the brain is empty. The reading comprehension area is mainly formed between the parietal lobe and the occipital lobe, and the sensory speech area of Wernicke is formed in a region of the temporal lobe close to the reading comprehension area.

That is, when the cortex of the brain develops for linguistic ability, a region of the cortex close to the temporal lobe may be more important as the linguistic ability relates to hearing, and a region of the cortex close to the occipital lobe and parietal lobe may be more important as the linguistic ability relates to the sense of sight.

The lower portion of FIG. 1 illustrates images of a person which are colored and 3D-processed after capturing the images by magnetic resonance imaging (MRI) so as to clearly illustrate thickness variations of the cortex of the brain and density variations of the gray matter of the brain after the person masters the Tetris game over a predetermined period of time.

The left image shows thickened regions of the cortex. That is, referring to marked regions of the left image, it can be estimated that all the tissue of the brain has developed after mastering the game. The right image shows regions of the cortex where the density of the gray matter has increased. The white mater functions as a neuropil, and the gray matter functions as a storage and processor. That is, referring to the right image, it can be estimated that the logical circuit of the brain became more efficient after mastering the game. Generally, the logical circuit of the brain has developed more in a region close to the frontal lobe.

Generally, the logical circuit of the brain has developed more in a region close to the frontal lobe of the right brain. In a region close to the parietal lobe, temporal lobe, and occipital lobe, a cortex having a primary sensory processing function has developed.

From that, the direction of brain development can be found out for English speed reading which is a visual activity like playing a game and for which speed, accuracy, and structural combination are important.

Optimizing regions of the temporal lobe, parietal lobe, and occipital lobe close to the left brain (right eye) is a method for developing primary processing abilities such as rapidly catching sentences and sequentially interpreting the sentences. That is, it may be preferable to intensively develop mathematical and logical processing abilities of the left brain for exact interpretation of middle-length or short sentences.

On the other hand, secondary (higher) abilities such as remembering or catching the whole writing and figuring out the context of writing and predicting the next part of writing can be developed by optimizing a region of the frontal lobe close to the right brain (left eye). In other words, it may be preferable to intensively develop the spatial processing ability and the double meaning comprehension ability of the right brain for comprehensive and conceptual understanding of a long sentence and rewriting based on understanding on captured facts.

This conclusion relates to movement of eyeballs. In the culture of reading text from the left to the right, a sentence written in English is also read from the left to the right. When carefully reading a sentence the construction of which is continuous, the right eye can easily move from left to right and be effectively connected to the left brain. On the other hand, when a person reads a long sentence written in a plurality of lines, he may unconsciously refer to the previous line while turning his eyes from right to left, or he may catch the general meaning of the left side (current) of a line while predicting the content of the next right side (future) of the line. Therefore, if the same sentence structures are repeated or sentences having similar meanings are consecutively arranged in a paragraph or sentences are connected in meaning so that the next sentence can be unconsciously predicted, the left eye can be easily turned from right to left. In addition, while moving the left eye to the right, the content of the left side can be retained. Thus, the left eye can be effectively connected to the right brain.

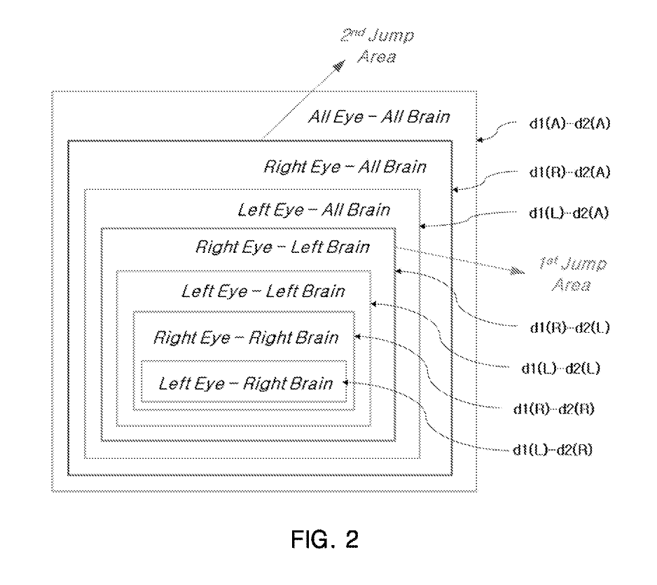

According to the up-to-now studies, the above-described brain visual processing patterns that are the basis of the technical characteristics of the present invention are in accord with the characteristics of the left and right brains of humans. FIG. 2 is a view showing levels of measurement variables of brain visual processing patterns used for a playing method of the present invention.

In FIG. 2, the brain visual processing pattern classified to the lowest level in FIG. 2 is a combination of the left eye and the right brain. That is, the visual processing pattern of the lowest level is based on typical right-brain thinking, and thus sequential interpretation and English speed reading are difficult. However, since this applies to the case of non-native English speakers, such right brain thinking may not be problematic in English speed reading for the case of highly educated native English speakers.

Many of right-brain people have developed right eyed owing to the light based culture of our society. Such people can logically scan English sentences from left to right as compared with people whose left eyes are developed.

Referring to FIG. 2, the brain visual processing patterns are graded in the order of left eye—left brain, right eye—left brain, etc. The right-eye-left-brain type, which has the largest area and highest level in a region indicated by a thick line is a typical left brain thinking type, is an optimal visual processing pattern for rapidly reading middle-length and short sentences.

In the prior application, basic dynamic English graphics for reaching the right-eye-left-brain level has disclosed. Although 200 to 400 words can be read per minute at the level, the present invention is provided for learners who want to jump one or more levels. Referring to FIG. 2, levels of using both left and right brains are next to a first jump area indicated by a thick line. Referring to FIG. 2, levels are sequentially arranged in the order of left eye—all brains, right eye—all brains, and all eyes—all brains. 1000 or more words can be read per minute at the all-eye-all-brain level which is better than the reading ability of highly educated native English speakers.

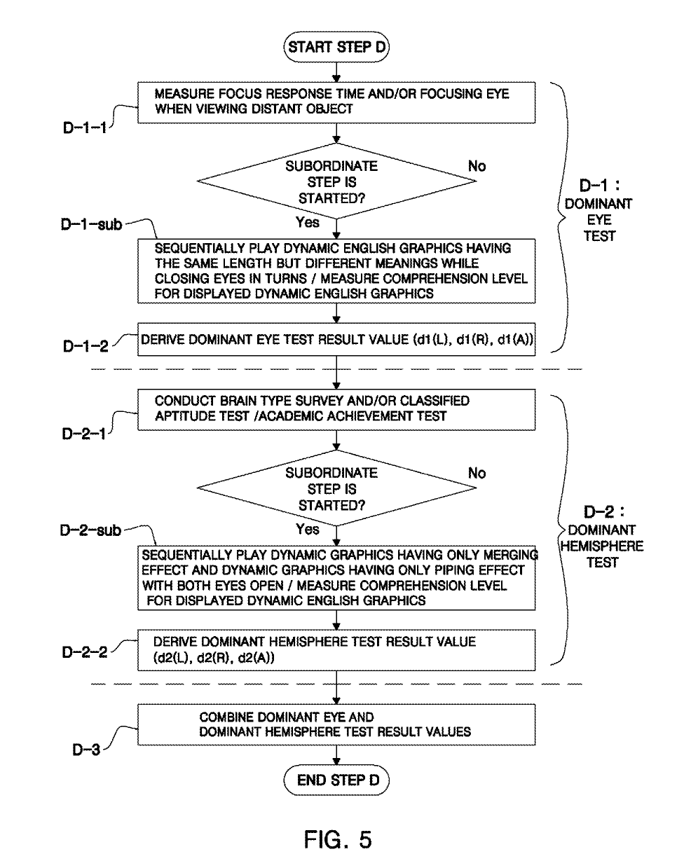

Reference numerals in FIG. 2 are used as variables for indicating levels of vision and brain parts when Sub Steps D-1 and D-2 of Step D are explained with reference to FIG. 5. For example, d1(L)-d2(R) means that the left eye is dominant in a dominant vision determination step d1 and the right eye is dominant in a dominant hemisphere determination step d2. The reference numerals can be easily used as process parameters in computer code. The all-eye-all-brain level next to a second jump area is coded as d1(A)-d2(A) in which A means all.

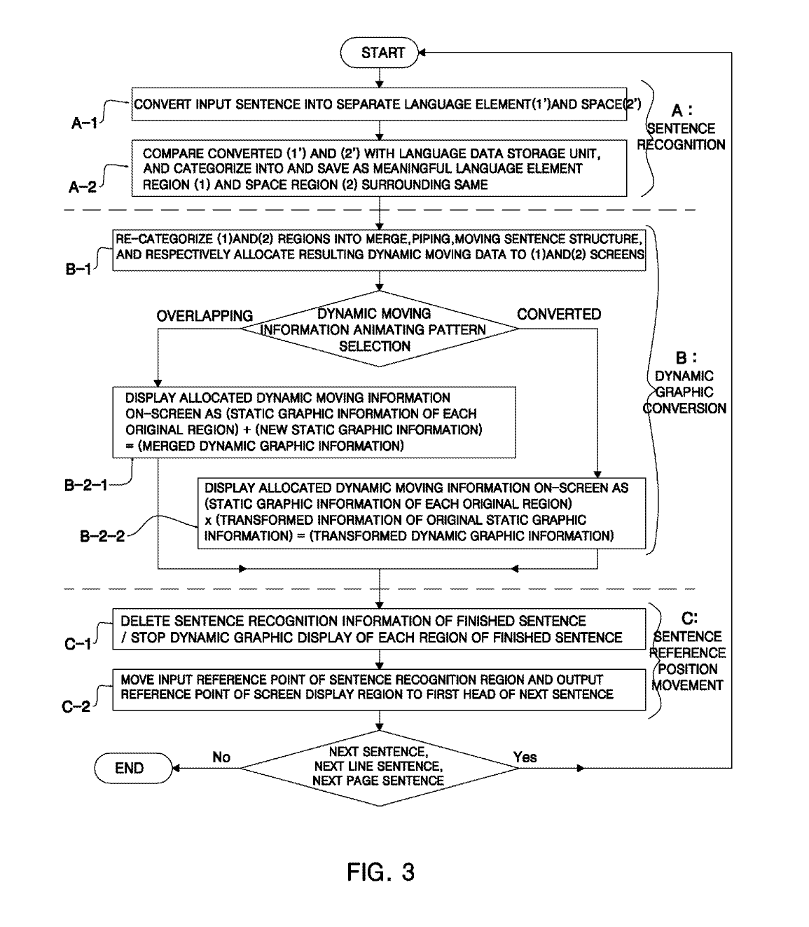

FIG. 3 is a flowchart for explaining a basic method of playing dynamic English graphics which is disclosed in the prior application. In the following description of dynamic English graphic processing of the present invention, the basic dynamic change mechanism of separate language elements 1 is explained according to time. Briefly, procedures are as follows:

First, a sentence recognition step A is performed, which includes Step A-1 of converting input sentences into spaces and separate language elements, and Step A-2 of recognizing the converted spaces and separate language elements and comparing them to data in a language data storage unit to separate and store them into meaningful language element regions 1 and space regions 2 surrounding the element regions.

Next, a dynamic graphic conversion step B is performed, which includes: Step B-1 of matching sentence data derived through Step A, re-categorizing the data into the 3 types of main sentence assembly steps according to Universal Grammar, and allocating the resultant dynamic moving information to each language element region 1 and each space region 2; and Step B-2 of inserting predetermined symbols for the allocated dynamic moving information into original static graphic information for each region to transform into new static graphic information to be displayed on-screen, or transform the static graphic information itself for each region into new dynamic graphic information to be displayed on-screen.

A sentence reference position moving step C is performed, which includes: Step C-1 in which recognition information on the first sentence is deleted and dynamic graphic conversion is stopped when Steps A and B are completed for the first sentence, in order for Steps A and B to be continuously performed; and Step C-2 in which the reference points of the recognized region and an on-screen display region are moved to the head of the next sentence, in order to allow Steps A-1 through B-2 to be repeated1y performed on the next sentence or the sentence on the next line.

Thereafter, Steps A, B, and C are repeated while a sentence inputted in a computer is displayed across a screen and presented to a user as a page of a book. Then, unlike a typical computer book screen, the sentence assembly structure, in accordance with Universal Grammar, is displayed in an overlapped and dynamic (animated) manner, to allow a user to repetitively read the sentence to develop the user's viewing perspective that systematically seeks the separate language elements of the sentence and their combined structure.

For effectively displaying the operation mechanism of a certain action such as a merging action, dynamic graphic conversion B-2-2 in which meaningful separate language elements 1 get close through protruding, scaling down, or deleting may be more effective than static graphic conversion B-2-1 performed by overlapping.

The time-based processing steps of the present invention include: Steps A, B, and C for playing basic dynamic English graphics; and Steps D, E, F, and G for preventing confusion in understanding meaning That is, substantially, Step D is the first step of the present invention.

Steps A, B, and C are basic processing steps carried out before Step G in which dynamic change directions are varied or dynamic change is accelerated in a playing method including a merging, piping, or moving action in accordance with Universal Grammar. In other words, Steps A, B, and C may not be carried out before Step D of the present invention.

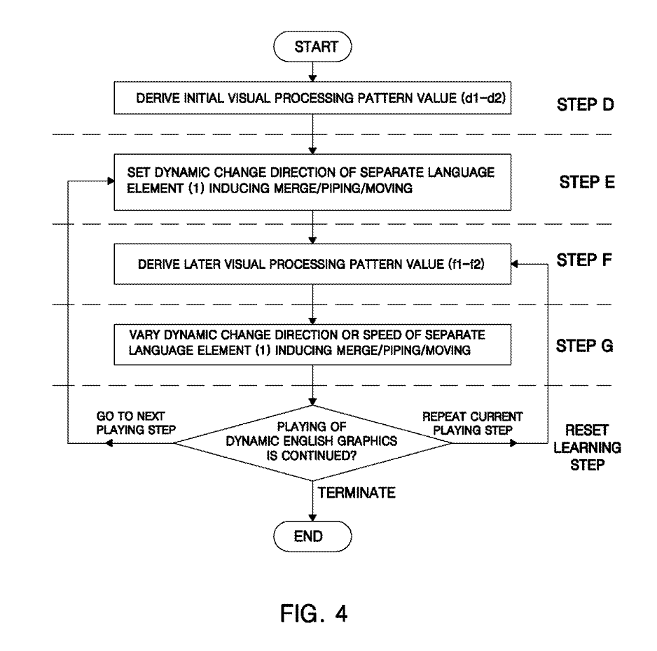

FIG. 4 is a flowchart for explaining steps of a method for playing optimal dynamic English graphics according to the present invention.

Dynamic English graphics optimized to visual processing patterns of a brain is played for a user as follows. In Step D, an initial visual processing pattern value d1-d2 of a user is derived.

In Step E, the dynamic change direction of each separate language element 1 inducing merging, piping, or moving is set according to the derived initial visual processing pattern value d1-d2.

Next, Step F is performed to derive later visual processing pattern value f1-f2, and Step G is performed to vary the dynamic change direction or dynamic change speed of each separate language element 1 based on the visual processing pattern value f1-f2.

Playing of dynamic English graphics changed through Step G may be terminated, or the procedure may go to the next step automatically or be repeated according user's selection.

d1(X)-d2(X) is used to denote the visual processing pattern in accordance with the concept explained with reference to FIG. 2, and such coding method may also be used in Step F in which the visual processing pattern is re-inspected.

Next, a detailed description will be given on a step of deriving a visual processing pattern value such as Step D of deriving vales d1(L, R, A)-d2(L, R, A).

FIG. 5 is a detailed flowchart for explaining Step D of the method for playing dynamic English graphics explained with respect to FIG. 4. First, an explanation is given on Step D-1-1 in which the dominant eye is detected as one of factors affecting brain visual processing pattern value. The dominant eye can be found out by measuring the response times of the foci of eyes using a pupil tracing device while playing certain English graphics from right to left or left to right. For example, if the pupils of the left and right eyes move at the same speed in response to graphics rapidly moving to the right side, the right eye is not dominant because the right eye can move more faster. In addition, if the left and right eyes rotate different angles in response to graphics rising rapidly, the eye that rotates a smaller angle is dominant because the eye can track the graphics with less movement.

In addition, when one sees a distant object through a ring formed by his fingers, if the object is seen as it was after closing his one eye, the other eye is the dominant eye. The biological dominant eye can be found out in these methods.

Regardless of the biological dominant eye, the dominant eye in visual processing patterns of a brain can be found out exactly by Step D-1-sub. In Step D-1-sub, dynamic English graphics having the same length but different meaning are sequentially played while closing user's eyes in turns, and it is measured how much the graphics are understood. In this case, the graphics can be easily accessed by a side of the brain of the user opposite to the opened eye, and if the graphics are coincident with the thinking patterns of the side of the brain, the side of the brain may understand the graphics to the same degree as in the case where both eyes are opened. Otherwise, the close eye and the other side of the brain connected to the closed eye may be dominant.

If graphics are understood to substantially the same degree when any one of the two eyes is closed and the focus response times of both eyes are substantially equal in Step D-1, it may be determined that both eyes (all eyes) are dominant (d1(A)).

An explanation will now be given of a dominant eye test in Step D-2. In Step D-2-1, the brain type is determined whether it is a left-brained type d2(L) or a right-brained type d2(R) through a general brain type survey, a classified aptitude test, and/or a classified academic achievement test. In some cases, the brain type may be an all-brain type d2(A).

Like in Step D-1, a test step may be additionally performed to determine the brain type based on visual processing patterns of a brain, that is, based on a manner optimized to the present invention. In Step D-2-sub, dynamic graphics having only a merging effect and dynamic graphics having only a piping effect are sequentially played in a state where user's both eyes are not closed, and how much the graphics are understood is tested to reflect the test result to the result of the above dominant hemisphere test.

Referring to the prior application, the merging action (marching of divided content) generally requires right-brained thinking because meanings of neighboring separate language elements are combined while referring to previous separate language elements, and the piping action (connecting related elements) generally requires left-brained thinking because meanings of consecutive separate language elements are combined rapidly and sequentially. Therefore, if English graphics in which the one of the actions is largely varied in a dynamic manner (in a state where moving action is added to or not added to both the actions), a user may understand the English graphics to different degrees according to the visual processing pattern characteristics of the user.

The results of the above-described dominant eye and brain tests may be expressed as d1(A, R, L) and d2(A, R, L) and be combined. Although one of Steps D-1 and D-2 is omitted, at least three resultant values can be obtained. If results of Steps D-1 and D-2 are combined, seven resultant vales can be obtained. That is, the visual processing patterns of a brain or the structural sensitivity of a brain to structures and actions of English sentences can be classified into three to seven levels.

Next, in Step E, the dynamic change direction of each separate language element of English graphics is set based on the initial visual processing pattern value derived in Step D.

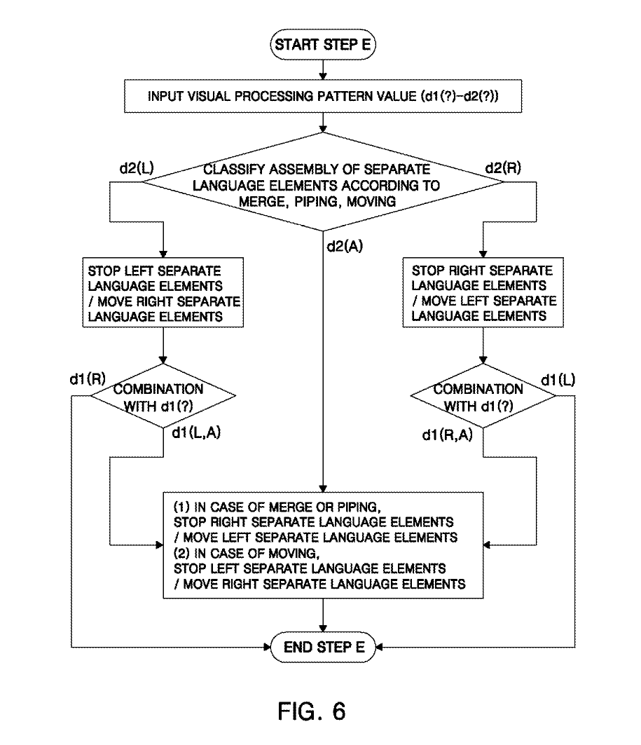

Referring to the flowchart of Step E shown in FIG. 6, first, a process system that manages dynamic changes of sentence date analyzes sentences each including separate language elements so as to select a suitable one of merging, piping, and moving actions for each sentence and classify the sentences according to the actions. Here, the visual processing pattern value derived in Step D is input. First, it is determined how the merging, piping, and moving actions are performed based on the dominant hemisphere value d2.

For example, if a left-brained type d2(L) is input, a dynamic change action is selected such that right separate language elements are stopped and left separate language elements. The selected dynamic change action is a right-brained language processing pattern for maximizing an overall and comprehensive right-to-left referring action so as to optimally compensate for demerits of the left-brained language processing mechanism. Next, if a right eye dominant type d1 (R) is input, it is determined that a user has a typical left-brained and right-eye-dominant type with a sequentially and continuous thinking mechanism, and the pattern for maximizing an overall and comprehensive right-to-left referring action (motion pattern for compensating for demerits of the inherent linguistic ability of the user) is maintained.

In another example, if a right-brained type d2(R) is input, a dynamic change action is selected such that left separate language elements are stopped and right separate language elements. The selected dynamic change action is a left-brained language processing pattern for maximizing left-to-right causal progress so as to optimally compensate for demerits of the right-brained language processing mechanism. Then, if a left-eye-dominant type d2(L) is input, it is determined that the user has a typical right-brained and left-eye-dominant type with an overall and comprehensive thinking mechanism, and the pattern for maximizing left-to-right causal progress is maintained.

Another example will now be explained. A user may have a right-eye-dominant and right-brained type, a left-eye-dominant and left-brained type, or a whole-brained type.

In this case, an optimized dynamic change pattern is provided from the first because the brain tendency of the user is not strong. Referring to FIG. 6, in process step (1), when separate language elements are dynamically changed according to a merging or piping action, it is set such as right separate language elements are stopped, and left separate language elements are moved. In process step (2), when separate language elements are dynamically changed according to a moving action, it is set such as left separate language elements are stopped, and right separate language elements are moved.

That is, the merging and piping actions mainly used for short and middle-length sentences are dynamically changed for optimization to left-brained visual processing patterns, and the moving action mainly used for long sentences or paragraphs is dynamically changed for optimization to right-brained visual processing patterns. This is the core concept of the dynamic English graphic playing method of the present invention.

Therefore, users who are good at overall and comprehensive reading but poor at reading difficult paragraphs or understanding sentences having subtle different meanings can make up for their weaknesses because they can develop rapid and exact comprehension abilities for short and middle-length sentences through repetition of the above-described process steps. In additional, users who are good at rapid and exact reading of short, complicated, and difficult sentences but are easily tired or have difficulty in catching or remembering the subject or context when reading a large amount of writing can make up for their weaknesses because they can develop overall comprehension abilities for long sentences through repetition of the above-described process steps. In other words, all functions of left and right brains can be linked for English speed reading. Eventually, all the functions of a brain can evenly be used, and thus the average process load of each region of the brain can be reduced. This is exactly consistent with the above-described concept of gray matter density increase.

Thereafter, in Step F, a later visual processing pattern value f1-f2 is derived like in Step D to measure the learning effect in Step E and a change of the visual processing pattern of the brain. Next Step G includes: Step G-1 in which the dynamic change directions of separate language elements are varied if the later visual processing pattern value is equal to the initial visual processing pattern value; and Step G-2 in which the dynamic change speeds of the separate language elements are increased for maintaining the later visual processing pattern value if the later visual processing pattern value is different from the initial visual processing pattern value.

Step G-1 is performed to find out another optimized dynamic change pattern if it is determined from a re-inspection result that the brain visual processing pattern of a user is not improved after dynamic English graphics are played.

Step G-2 is performed to increase the speed of the current dynamic change pattern for further improving the academic achievement of the user if it is determined from the re-inspection result that the brain visual processing pattern of the user is meaningfully improved after dynamic English graphics are played.

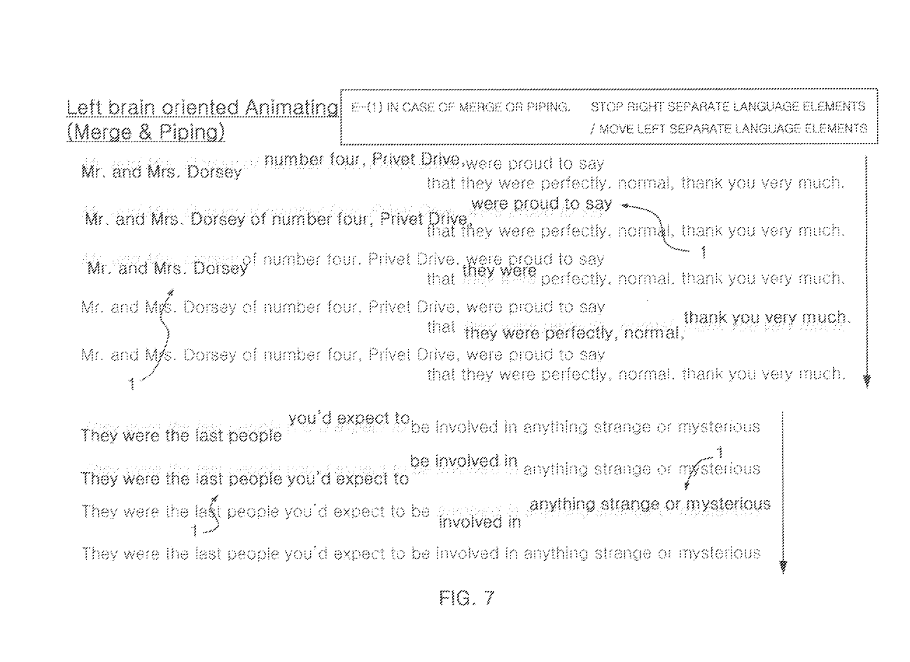

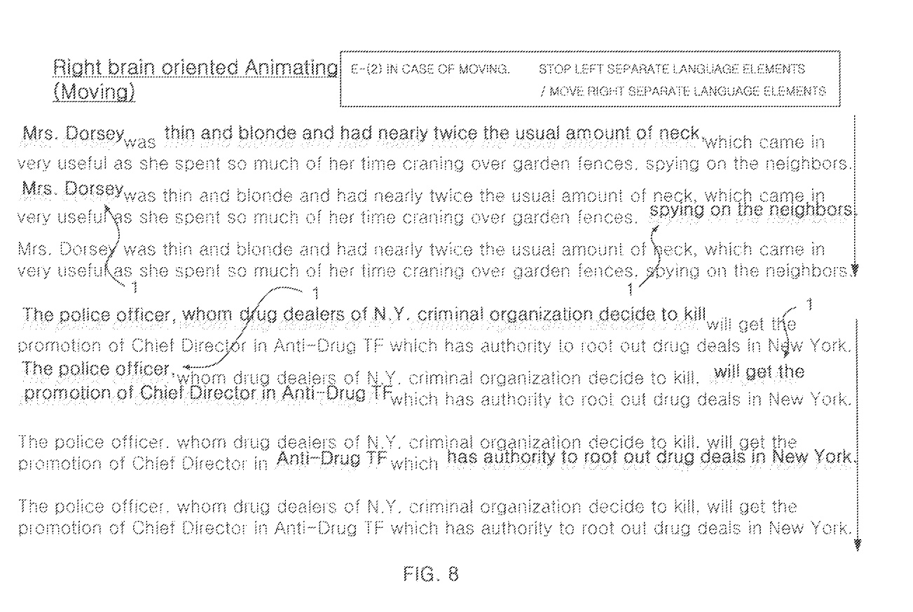

The above-described change aspects of dynamic English graphics are illustrated in FIGS. 7 and 8.

FIG. 7 sequentially illustrates an exemplary optimized change pattern of dynamic English graphics mentioned in the description of Step E, in which when separate language elements are dynamically changed with merging or piping, right separate language elements are stopped and left separate language elements are moved. FIG. 8 sequentially illustrates a dynamic change pattern, in which when separate language elements that are dynamically changed with moving, left separate language elements are stopped and right separate language elements are moved. In FIGS. 7 and 8, letters disappearing as they fade are expressed in italic font, and letters arranged at the upper or lower side of the italic letters and becoming darker or fading in are expressed in bold font. Such letter effects are shown more clearly in the accompanying drawings of the prior application: Korean Patent NO. 10-0968364 (Application No. KR-2009-0121688) to which the present application claims priority.

The examples shown in FIGS. 7 and 8 are exemplary embodiments of the present invention, which can be modified according to separate language elements and selection of Universal Grammar's three actions. Such modifications or changes are included within the dynamic playing concept of the present invention as long as such modifications or changes follow the concept of the present invention emphasized throughout the present disclosure. That is, as long as the visual processing pattern of a brain can be intentionally changed by stimulating the eyes and the brain connected with the eyes so as to make it possible to use both left and right brains for English speed reading and thus to reduce the process load of unit area of the brain but increase the total process amount and rate of the brain, any modifications or changes are included within the dynamic playing concept of the present invention.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

According to the present invention, the dynamic English graphic playing method can be used as a powerful speed reading animating learning tool for learners in non-English speaking countries around the world when the dynamic English graphic playing method is combined with a dominant eye and brain determination method that can be carried out through the internet.

While the present invention can induce ample and accurate brain stimulation even under present circumstances in which automated translation artificial intelligence is not yet completely capable, it will enable sophisticated and optimized brain training once patterns are additionally generated in advance for dictionaries and set dynamic sentence data are revised and supplemented by humans. This may develop into a new English teaching business model.

When the method of the present invention is carried out at an institute fully equipped with systems for analyzing eyeball tracking and brain scanning, English learners may get an excellent effect within a short period. In addition, materials on teaching and observation accumulated in such an institute may be analyzed to extract English sentences that are difficult for non-English-speaking users to interpret so as to use the extracted English sentences for various advanced industrial purposes such as allocating the extracted English sentence to translating machines having artificial intelligence.

What is claimed is:

1. A dynamic English graphic playing method for enacting actual merging, piping, or moving according to Universal Grammar, the method comprising the steps of:
D) deriving an initial visual processing pattern value of a user;
E) setting dynamic change directions of separate language elements according to the initial visual processing pattern value so as to induce merging, piping, or moving;
F) deriving a later visual processing pattern value of the user; and
G) varying the dynamic change directions of the separate language elements or dynamic change speeds of the separate language elements according to the later visual processing pattern value.

2. The dynamic English graphic playing method of claim 1, wherein the separation space comprises the steps of:
D-1) deriving the initial visual processing pattern value from at least three combinations of dominant eye test result values (d1(L), d1(R), and d2(A)); and
D-2) deriving the initial visual processing pattern value from at least three combinations of dominant hemisphere test result values (d2(L), d2(R), and d2(A)).

3. The dynamic English graphic playing method of claim 2, wherein the step (D-1) comprises the step (D-1-sub) of testing user's understanding after sequentially playing dynamic English graphics having the same length but different meanings in a state where the eyes of the user are closed in turns, so as to reflect results of the user's understanding test when deriving the dominant eye test result values.

4. The dynamic English graphic playing method of claim 2, wherein the step (D-2) comprises the step (d-2-sub) of testing user's understanding after playing dynamic English graphics with only a merging action and then playing dynamic English graphics having the same length and only a piping effect in a state where both the eyes of the user are not closed, so as to reflect results of the user's understanding test when deriving the dominant hemisphere test result values.

5. The dynamic English graphic playing method of claim 1, wherein the step (E) is performed so that when the separate language elements are dynamically changed according to a merging or piping action, right separate language elements are stopped and left separate language elements are moved, and when the separate language elements are dynamically changed according to a moving action, the left separate language elements are stopped and the right separate language elements are moved.

6. The dynamic English graphic playing method of claim 5, wherein if the later visual processing pattern value is equal to the initial visual processing pattern value, the step (G) comprises the step (G-1) of varying the dynamic change directions of the separate language elements to change the later visual processing pattern value.

7. The dynamic English graphic playing method of claim 6, wherein if the later visual processing pattern value is different from the initial visual processing pattern value, the step (G) comprises the step (G-2) of varying the dynamic change speeds of the separate language elements so that the later visual processing pattern value is maintained.
